(19) United States
(12) Patent Application Publication
(10) Pub. No.: US 2017/0307022 A1
(43) Pub. Date: Oct. 26, 2017

(54) Shaft-Hub Connection As Well As Method For The Assembly And Disassembly Of The Same

(71) Applicant: RENK AKTIENGESELLSCHAFT, Augsburg (DE)

(72) Inventor: Burkhard PINNEKAMP, Augsburg (DE)

(73) Assignee: RENK AKTIENGESELLSCHAFT

(21) Appl. No.: 15/489,420

(22) Filed: Apr. 17, 2017

(30) Foreign Application Priority Data
Apr. 21, 2016 (DE) 102016206828.8

(51) Int. Cl. F16D 1/08

(52) U.S. Cl. CPC F16D 1/08; F16D 2250/0084

(57) ABSTRACT

A shaft-hub connection with a shaft that includes a section with external splines, and a hub that includes internal. The hub with its internal splines is assembled in a positively joined manner with play on the section of the shaft including the external splines. The shaft in the section includes the external splines has a recess regularly inside of the external splines, in which a clamping body is inserted neutralizing the play between shaft and hub.

### BACKGROUND OF THE INVENTION

### 1. Field of the Invention

The invention relates to a shaft-hub connection and a method for establishing or assembling and to a method for dissolving or disassembling such a shaft-hub connection.

### 2. Description of the Related Art

Shaft-hub connections can be embodied positively joined for torque transmission. Accordingly it is usual to assemble a hub with its internal splines on a section of the shaft comprising external splines, preferentially with play. Assembling the positive connection between shaft and hub with play is advantageous in order to easily make possible the assembly and a subsequent disassembly. The assembly with play however can be disadvantageous for reasons of undesirable noise development during operation, an undesirable imbalance, and increased wear. The assembly of the hub on the shaft free of play for example by way of a press fit with oversize of the shaft renders the assembly and disassembly of the shaft-hub connection more difficult.

### SUMMARY OF THE INVENTION

There is a need for a shaft-hub connection, with which the disadvantages of the shaft-hub connections known from practice can be eliminated, i.e. which can be easily assembled and disassembled with little noise development, little imbalance, and little wear.

One aspect of the present invention is based on creating a new type of shaft-hub connection and to a method for establishing or assembling as well as dissolving or disassembling the same.

This object is solved through a shaft-hub connection according to one aspect of the invention in which, the shaft comprises a recess in the section comprising the external splines radially inside of the external splines, in which a clamping body neutralizing the play between shaft and hub is inserted.

With the shaft-hub connection according to the invention, the positively joined connection of hub and shaft via the usually play-affected intermeshing splines is configured free of play through the clamping body, which serves for expanding the section of the shaft comprising the external splines. Ensuring a simple assembly and disassembly, undesirable noise developments, an undesirable imbalance and undesirable wear can be counteracted.

According to an advantageous further development, the recess is contoured cone-like or funnel-like and tapers, starting out from the axial end of the shaft to the inside into the shaft, wherein the clamping body is correspondently contoured cone-like or truncated cone like and particularly advantageously has an outer diameter at least in sections larger than an adjoining inner diameter of the recess. A particularly advantageous assembly of the hub on the shaft neutralizing the play of the play-affected splines between shaft and hub is thereby possible.

Preferentially, the clamping body comprises a hydraulic connection and hydraulic lines via which during the assembly and/or disassembly of the clamping body in the recess of the shaft the recess can be radially expanded. By way of the hydraulic connection and the hydraulic lines, a particularly advantageous assembly and/or disassembly of the shaft-hub connection is possible.

Preferentially, a disc secures the clamping body that is inserted in the recess. The shaft-hub connection can thereby be secured against unintentional disconnection.

The method for establishing or assembling the shaft-hub connection is defined.

The method for dissolving or disassembling the shaft-hub connection is defined.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Preferred further developments of the invention are obtained from the subclaims and the following description. Exemplary embodiments of the invention are explained in more detail by way of the drawing without being restricted to this. There it shows:

FIG. 1: is a shaft-hub connection according to the invention in cross section.

### DETAILED DESCRIPTION OF THE PRESENTLY PREFERRED EMBODIMENTS

The present invention relates to a shaft-hub connection, to a method for establishing or assembling such a shaft-hub connection, and to a method for dissolving or disassembling the shaft-hub connection.

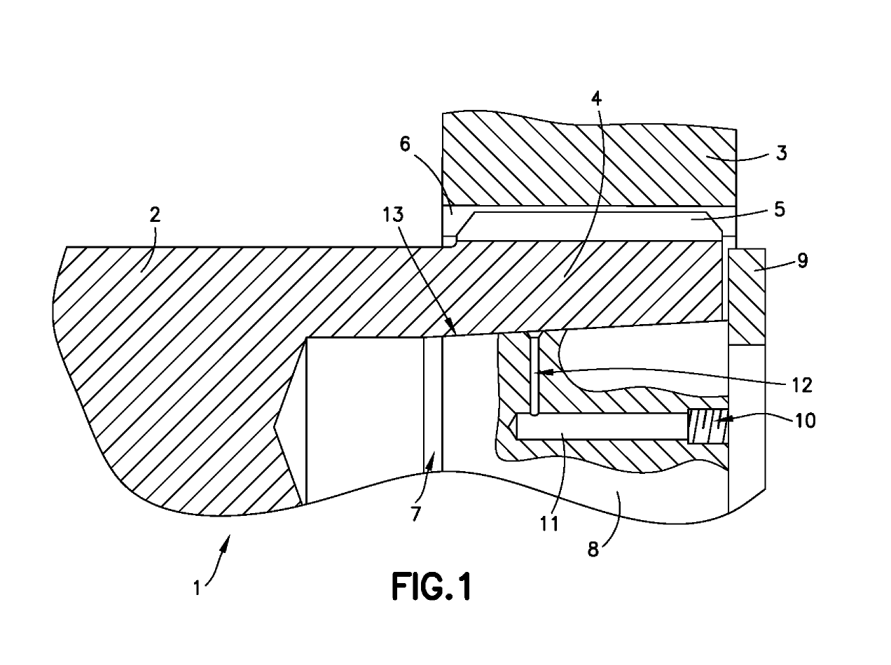

FIG. 1 shows an extract from a shaft-hub connection 1 according to one aspect of the invention between a shaft 2 and a hub 3. The shaft 2 comprises a section 4 with external splines 5, wherein the hub 3 comprises internal splines 6, and wherein the hub 3 with its internal splines 6 is assembled in a positively joined manner with play on the section of the shaft 2 comprising the external splines 5.

In the section 4 carrying the external splines 5, the shaft 2 comprises a recess 7 radially inside of the external splines 5. In this recess 7, a clamping body 8 is inserted, namely subject to neutralizing the play between the inherently play-affected positively joined connection between shaft 2 and hub 3, which is provided via the intermeshing splines 5, 6 of shaft 2 and hub 3.

The clamping body 8 has an outer diameter at least in sections that is larger than the inner diameter of the recess 7, so that the clamping body 8 inserted in the recess 7 of the shaft 2 expands the section 4 of the shaft, which carries the external splines 5, neutralizing the play between the splines 5, 6 preferentially creating a preload between shaft 2 and hub 3.

Any centering faces formed in the region of the splines 5, 6 on shaft 2 and hub 3 can also be rendered free of play by the clamping body 8.

In the shown preferred exemplary embodiment, the recess 7 in section 4 of the shaft 2 is contoured cone-like or funnel-like namely in such a manner that the recess 7, starting out from the axial end of the shaft 2, tapers in axial direction towards the inside into the shaft 2. The clamping body 8 is correspondingly contoured cone like or truncated cone-like namely as already explained in such a manner that an outer diameter of the same is larger at least in sections than a corresponding, in the assembled state, adjoining or opposite inner diameter of the recess 7.

The clamping body 8 inserted in the recess 7 of the shaft 2 can be secured by way of an optional disc 9 in its position within the shaft 2 in which it is inserted in the recess 7.

The clamping body 6 preferentially comprises a hydraulic connection 10 and hydraulic lines 11, 12. By way of the hydraulic connection 10 and the hydraulic lines 11, 12, the recess 7 of the shaft can be radially expanded during the assembly and/or disassembly of the clamping body 8 in the recess 7 of the shaft 2 in order to insert the clamping body 8 in the recess 7 during the assembly of the shaft-hub connection 1 or in order to remove the same from the recess 7 during the disassembly of the shaft-hub connection 1.

A hydraulic system, which is not shown, can be connected to the hydraulic connection 10, wherein hydraulic oil can be conducted via the hydraulic lines 11, 12 in the direction of a contact region 13 between the outer diameter of the clamping body 8 and the inner diameter of the recess 7 of the shaft 2. Here, the hydraulic line 11 extends in axial direction and the hydraulic line 12 in radial direction.

For establishing or assembling such a shaft-hub connection 1, a shaft 2, with a section 4 comprising the external splines 5, and the recess 7, and a hub 3 with internal splines 6 are provided. Furthermore, a clamping body 8 is provided, which at least in sections, has an outer diameter that is at least in sections larger, in the assembled state, than an adjoining or opposite inner diameter of the recess 7 of the section 4 of the shaft 2. The hub 3 is assembled on the shaft 2 in a positively joined manner, preferentially with play between the internal splines 6 of the hub 3 and the external splines 5 of the shaft 2 on the section 4 of the same. Following this positively-joined, preferentially play-affected assembly of the hub 3 on the section 4 of the shaft 2 the clamping body 8 is assembled in the recess 7 of the shaft neutralizing the play between the shaft 2 and the hub 3 preferentially generating a preload between shaft 2 and hub 3.

To this end, either the clamping body 8 can be cooled down relative to the section 4 of the shaft 2 and/or the section 4 of the shaft 2 comprising the external splines 5 can be warmed up or heated relative to the clamping body 8. Because of this, the relative oversize of the clamping body 8 can be thermally neutralized relative to the recess 7 of the shaft 2 in order to simply insert the clamping body 8 in the recess 7 of the shaft 2. Following temperature equalization, a press fit then exists between clamping body 8 and section 4 of the shaft 2, which radially expands the section 4 of the shaft 2, in this way neutralizing the play between the splines of hub 3 and shaft 2.

Alternatively or additionally, the section 4 of the shaft 2 comprising the external splines 5 and the recess 7 can be hydraulically expanded for assembling the clamping body 8 in the recess 7 of the shaft 2, namely utilising the hydraulic connection 10 and the hydraulic lines 11, 12 of the clamping body 8.

The clamping body 8 inserted in the recess 7 of the shaft 2 can be subsequently secured via the disc 9 in its position within the shaft 2 in which it is inserted in the recess 7. To this end, the disc 9 is preferentially assembled on the shaft 2 via a screw connection.

For disassembling or disconnecting the shaft-hub connection 1, the optional disc 9 is initially removed and the clamping body 8 then removed from the recess 7 of the shaft 2 re-establishing the play between the shaft 2 and the hub 3, wherein subsequently the hub 3 is disassembled from the shaft 2. For disassembling the clamping body 8 from the recess 7 of the shaft 2, the section 4 of the shaft 2 comprising the external splines 5 and the recess 7 is radially expanded preferentially hydraulically utilising the hydraulic connection 10 and the hydraulic lines 11, 12 of the clamping body 8.

It is therefore in the interest of the present invention to create a shaft-hub connection 1 between a shaft 2 and a hub 3 that initially assembles the hub 3 on the shaft 2 in a positively joined manner with play via intermeshing splines 5, 6, wherein subsequently via the clamping body 8 inserted in the recess 7 of the shaft 2 the play between the splines 5, 6 is neutralized preferentially subject to generating a preload between shaft 2 and hub 3. To this end, the clamping body 8 is preferentially contoured truncated cone-like or cone like, wherein the recess 7 of the shaft 2 receiving the clamping body 8 is correspondingly contoured cone like or funnel-like.

During the assembly of the clamping body 8 in the recess 7 of the shaft 2 an oversize of the clamping body 8 at least in sections can be neutralized relative to the recess 7 of the shaft 2 at times by way of temperature differential and/or by utilising a hydraulic pressure, in order to position the clamping body 8 in the recess 7 of the shaft 2.

The assembly and disassembly of the clamping body 8 in the recess 7 of the shaft 2 and the assembly and disassembly of the hub 3 on the section 4 of the shaft 2 in each case take place in axial direction of the shaft 2.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A shaft-hub connection, comprising:
a shaft having a section with external splines and a recess radially inside the external splines;
a hub having internal splines,
wherein the hub with its internal splines is assembled in a positively joined manner with play on the section of the shaft comprising the external splines; and
a clamping body inserted in the recess and configured to neutralize the play between shaft and hub.

2. The shaft-hub connection according to claim 1, wherein the recess has one of a cone-like or funnel-like contour that starts at an axial end of the shaft and tapers towards an inside of the shaft.

3. The shaft-hub connection according to claim 1, wherein the clamping body has one of a cone-like or funnel-like contour and has an outer diameter at least in sections that is larger than a corresponding inner diameter of the recess.

4. The shaft-hub connection according to claim 1, wherein the clamping body comprises a hydraulic connection and hydraulic lines, via which during assembly and/or disassembly of the clamping body in the recess of the shaft, the recess is radially expanded.

5. The shaft-hub connection according to claim 1, further comprising a disc configured to secure the clamping body in the recess.

6. A method for assembling a shaft hub connection having a shaft with a section with external splines and a recess radially inside the external splines; a hub having internal splines; and a clamping body inserted in the recess, the method comprising:
providing the shaft with the section comprising the external splines and the recess,
providing the hub with the internal splines,
providing the clamping body,
positively-joined assembling with play of the hub with its internal splines on the section of the shaft comprising the external splines; and
assembling the clamping body in the recess of the shaft neutralizing the play between the shaft and the hub forming the shaft-hub connection.

7. The method according to claim 6, wherein prior to assembling the clamping body in the recess of the shaft the clamping body is cooled down relative to the section of the shaft comprising the external splines and the recess or the section of the shaft comprising the external splines and the recess is heated relative to the clamping body.

8. The method according the claim 6, wherein for assembling the clamping body in the recess of the shaft the section of the shaft comprising the external splines and the recess is hydraulically widened, by a hydraulic connection and hydraulic lines of the clamping body.

9. A method for the disassembling a shaft-hub connection having a shaft with a section with external splines and a recess radially inside the external splines; a hub having internal splines; and a clamping body inserted in the recess, the method comprising:
disassembling the clamping body from the recess of the shaft establishing play between the shaft and the hub; and
disassembling the hub from the shaft.

10. The method according to claim 9, wherein for disassembling the clamping body from the recess of the shaft the section of the shaft comprising the external splines and the recess is hydraulically widened, via a hydraulic connection and hydraulic lines of the clamping body.

11. The shaft-hub connection according to claim 2, wherein the clamping body has one of a cone-like or funnel-like contour and has an outer diameter at least in sections that is larger than a corresponding inner diameter of the recess.

12. The method according the claim 7, wherein for assembling the clamping body in the recess of the shaft the section of the shaft comprising the external splines and the recess is hydraulically widened, by a hydraulic connection and hydraulic lines of the clamping body.
